(19) United States
(12) Patent Application Publication
(10) Pub. No.: US 2011/0219312 A1
(43) Pub. Date: Sep. 8, 2011

(54) APPARATUS AND METHOD FOR DISPLAYING USER INTERFACE FOR TRANSMITTING CONTENTS

(75) Inventors: Yeo Jin KIM, Suwon-si (KR); Young Ho RHEE, Yongin-si (KR); Hyun Joo KANG, Suwon-si (KR)

(73) Assignee: SAMSUNG ELECTRONICS CO., LTD., Suwon-si (KR)

(21) Appl. No.: 12/963,988

(22) Filed: Dec. 9, 2010

(30) Foreign Application Priority Data
Mar. 4, 2010 (KR) 10-2010-0019390

(51) Int. Cl. G06F 3/01

(52) U.S. Cl. 715/739

(57) ABSTRACT

Provided is a digital apparatus displaying a user interface for a contents transmission. The digital apparatus generates and displays a user interface including a first area, a second area, and a third area, the first area displaying, based on the communication records, user lists up to a predetermined communication record rank among the plurality of user lists, the second area displaying, based on the usage records, contents lists up to a predetermined usage record rank among the plurality of contents lists, and the third area dynamically displaying at least one function menu list that is applicable to the plurality of the displayed contents lists.

CROSS-REFERENCE TO RELATED APPLICATION(S)

This application claims the benefit under 35 U.S.C. §119(a) of Korean Patent Application No. 10-2010-0019390 filed on Mar. 4, 2010, in the Korean Intellectual Property Office, the entire disclosure of which is incorporated herein by reference for all purposes.

### BACKGROUND

1. Field

The following description relates to a digital apparatus and a user interface displaying method that displays, on a screen, a user interface for transmitting contents.

2. Description of Related Art

As a digital apparatus, such as a mobile phone, a digital camera, a camcorder, and the like, has developed, the digital apparatus may share contents with another digital apparatus using wireless communication technologies, in addition to making a call, taking a picture, and recording a moving picture, and the like.

Generally, when a user of the digital apparatus, for example, the mobile phone, wants to transmit a picture, a moving picture, and other contents to another digital apparatus, the digital apparatus may perform following operations. The digital apparatus may access a storage place storing the contents, such as music, a picture, a moving picture, and the like, may select transmission target contents to be transmitted, may select an execution menu, for example, “sending file”, may set a target for the transmission, for example, phone numbers of another mobile terminal, and may execute the transmission. The operations may have a difference in an execution order depending on a digital apparatus. However, most of digital apparatuses may perform the five operations to transmit contents to another digital apparatus.

A conventional contents transmitting method may require a plurality of operations, and thus, a user convenience may decrease. The user may frequently select several digital apparatuses as the target for transmission and may frequently select several transmission target contents. Accordingly, when the user searches for and selects the target for transmission and the transmission target contents every time the user wants to execute contents transmission, the user convenience may decrease. Therefore, there is a need for the user interface for easily embodying the contents transmission.

### SUMMARY

In one general aspect, there is provided a digital apparatus, including: a communication record management unit configured to manage communication records corresponding to a plurality of user lists stored in advance, a contents usage record management unit configured to manage usage records corresponding to a plurality of contents lists stored in advance, a user interface generating unit configured to generate a user interface including a first area, a second area, and a third area, the first area displaying, based on the communication records, user lists up to a predetermined communication record rank among the plurality of user lists, the second area displaying, based on the usage records, contents lists up to a predetermined usage record rank among the plurality of contents lists, and the third area dynamically displaying at least one function menu list that is applicable to the plurality of the displayed contents lists, and a display unit configured to display the user interface.

The apparatus may further include that the communication record management unit is further configured to update the communication records each time a communication with another digital apparatus corresponding to one of the plurality of user lists is performed.

The apparatus may further include that the contents usage record management unit is further configured to update the usage records each time at least one contents list from among the plurality of contents lists is used.

The apparatus may further include that the user interface generating unit is further configured to: check the communication record management unit to extract user lists including communication records up to a predetermined rank, and arrange, on the first area, the extracted user lists in an order of a recent communication history to generate the user interface.

The apparatus may further include that the user interface generating unit is further configured to: check the contents usage record management unit to extract contents lists including usage records up to a predetermined rank, and arrange, on the second area, the extracted contents lists to generate the user interface.

The apparatus may further include that the display unit includes a touch screen is further configured to sense a touch of a user.

The apparatus may further include a controller configured to control the user interface generating unit to dynamically display, on the third area, at least one function menu list applicable to at least one contents list, in response to the at least one contents list being dragged, on the touch screen, from the second area of the user interface and being dropped on at least one user list on the first area.

The apparatus may further include that, in response to one of the at least one function menu lists being selected, the controller is further configured to control transmission, using the selected function menu list, of the dragged contents list to another digital apparatus corresponding to the user list where the dragged contents is dropped.

The apparatus may further include that the user interface further includes a selection area for the selection, in a side of each of the lists on the first area through the third area.

The apparatus may further include: an input unit configured to receive one of: a movement control signal for a movement in the selection area and a selection control signal configured to select the selection area, and a controller configured to: designate at least one selection area in each of the first area through the third area based on the movement control signal, and select the designated selection area in response to the selection control signal being inputted while the selection area is designated.

The apparatus may further include that the controller is further configured to control transmission of a contents list of the selection area selected from the second area to another digital apparatus corresponding to a user list of the selection area selected from the first area, using a function menu list of the selection area selected from the third area of the displayed user interface.

In another general aspect, there is provided a user interface display method, including: managing communication records corresponding to a plurality of user lists stored in advance, managing usage records corresponding to a plurality of contents lists stored in advance, generating a user interface including a first area, a second area, and a third area, the first area displaying, based on the communication records, user lists up to a predetermined communication record rank among the plurality of user lists, the second area displaying, based on the usage records, contents lists up to a predetermined usage record rank among the plurality of contents lists, and the third area dynamically displaying at least one function menu list that is applicable to the plurality of the displayed contents lists, and displaying the user interface.

The method may further include that the managing of the communication records includes updating the communication records each time a communication with another digital apparatus corresponding to one of the plurality of user lists is performed.

The method may further include that the managing of the usage records includes updating the usage records each time at least one contents list from among the plurality of contents lists is used.

The method may further include that the generating includes: extracting user lists including communication records up to a predetermined rank, and arranging, on the first area, the extracted user lists in an order of a recent communication history to generate the user interface.

The method may further include that the generating includes: extracting contents lists including usage records up to a predetermined rank, and arranging, on the second area, the extracted contents lists to generate the user interface.

The method may further include that the generating includes dynamically displaying, on the third area, at least one function menu list applicable to at least one contents list, in response to the at least one contents list being dragged, on the touch screen, from the second area of the user interface and being dropped on at least one user list on the first area.

The method may further include, in response to one of the at least one function menu lists being selected, transmitting, using the selected function menu list, the dragged contents list to another digital apparatus corresponding to the user list where the dragged contents is dropped.

The method may further include that the user interface further includes a selection area for the selection, in a side of each of the lists on the first area through the third area.

The method may further include: designating at least one selection area in each of the first area through the third area based on a movement control signal for a movement in the selection area, selecting the designated selection area in response to the selection control signal for selecting the selection area being inputted while the selection area is designated, and transmitting a contents list of the selection area selected from the second area to another digital apparatus corresponding to a user list of the selection area selected from the first area, using a function menu list of the selection area selected from the third area of the displayed user interface.

Other features and aspects may be apparent from the following detailed description, the drawings, and the claims.

### BRIEF DESCRIPTION OF THE DRAWINGS

FIG. 1 is a block diagram illustrating an example of a digital apparatus.

FIG. 2 is a diagram illustrating an example of utilizing a user interface and contents.

FIG. 3 is a diagram illustrating an example of a contents transmitting method using to the user interface of FIG. 2.

FIG. 4 is a diagram illustrating another example of a contents transmission method using the user interface of FIG. 2.

FIG. 5 is a diagram illustrating another example of a user interface.

FIG. 6 is a diagram illustrating a still another example of a user interface.

FIG. 7 is a diagram illustrating an example of a user interface display method.

FIG. 8 is a diagram illustrating an example of a contents transmitting method using a user interface.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

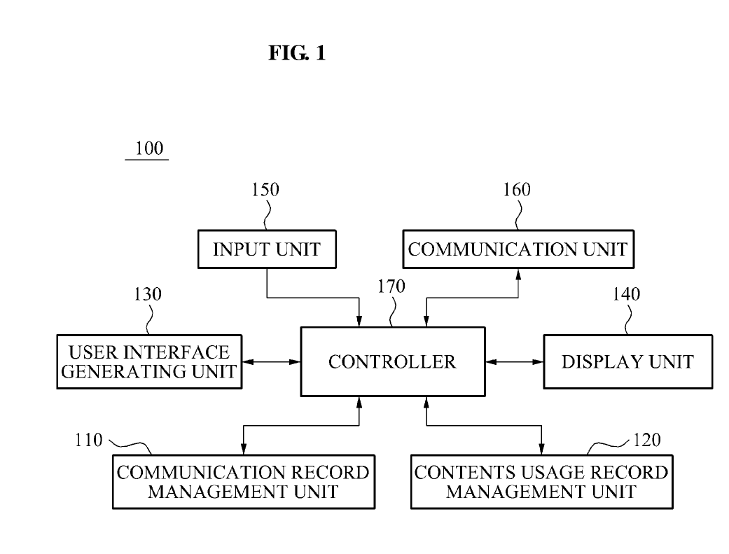

FIG. 1 illustrates an example of a digital apparatus 100. Referring to FIG. 1, the digital apparatus 100 may include a communication record management unit 110, a contents usage record management unit 120, a user interface generating unit 130, a display unit 140, an input unit 150, a communication unit 160, and a controller 170.

The digital apparatus 100 of FIG. 1 may be an apparatus, such as a mobile phone, a digital TV, a digital camera, a camcorder, etc. However, the apparatus may not be limited to the described examples, and may be another digital apparatus including a communication function or a display function.

The communication record management unit 110 may manage communication records corresponding to a plurality of user lists stored in advance. For example, the communication record management unit 110 may update the communication records to manage the communication records every time the digital apparatus 100 performs a communication with another digital apparatus corresponding to one of the plurality of user lists stored in advanced. In one example, a communication record may include a number of communications, a communication time, and the like. Each of the plurality of user lists may include a communication address or a phone number of another digital apparatus corresponding to itself.

The contents usage record management unit 120 may manage usage records corresponding to the plurality of contents lists. For example, the contents usage record management unit 120 may update the usage records to manage the usage records every time at least one contents list among the plurality of contents lists is used. In one example, a usage record of a contents list may be updated every time a user generates contents, accesses the contents list, or transmits the contents list to another digital apparatus.

The user interface generating unit 130 may generate a user interface for transmitting contents. In one example, the user interface may be provided to the user to enable the user to select a transmission target user list, a transmission target contents list, and a transmission target function menu list. Accordingly, the user may select, on a screen, the transmission target user list, the transmission target contents list, and the transmission target function menu list to transmit contents. Therefore, the contents may be easily transmitted.

The user interface generating unit 130 may generate the user interface based on the communication records recorded in the communication record management unit 110 and the usage records recorded in the contents usage record management unit 120. For example, the user interface generating unit 130 may include a first area, a second area, and a third area. The first area may display, based on the communication records, user lists up to a predetermined communication record rank among the plurality of user lists, the second area may display, based on the usage records, contents lists up to a predetermined usage record rank among the plurality of contents lists, and the third area may dynamically display at least one function menu list that is applicable to the plurality of the displayed contents lists.

The user interface generating unit 130 may display, on the user interface, all of the first area through the third area. The user interface generating unit 130 may display only the first area and the second area, and may display the third area by dynamically constructing a function menu list based on a contents list selected from the second area. In one example, the third area may be displayed as a popup window on a screen on which the first area and the second area are displayed. The function menu list displayed on the third area may be constituted by function menus that are applicable to the contents list selected from the second area. Particularly, applicable function menus may be different based on a type of contents, and thus, the function menu list may be dynamically changed based on the selected contents list.

For example, the user interface generating unit 130 may check the communication record management unit 110 to extract user lists having communication records up to a predetermined rank, and may arrange, on the first area, the extracted user lists in an order of a recent communication history, to generate the user interface. For example, in response to the predetermined rank being “4”, the user interface generating unit 130 may extract four user lists among user lists having communication records, and may arrange, on the first area, the extracted user lists in the order of the recent communication history.

The user interface generating unit 130 may check the contents usage record management unit 120 to extract contents list having usage records up to a predetermined rank, and may arrange, on the second area, the extracted contents list to generate the user interface.

The user interface generating unit 130 may reconstruct the function menu list according to the contents list selected from the second area, and may arrange the function menu list on the third area to generate the user interface.

A selection area for selecting a list may be included in one side of each list of the first area through the third area on the user interface.

The user list, the contents list, and the function menu list may be displayed in a form of a thumbnail on each area of the user interface.

The display unit 140 may display the user interface on the screen of the digital apparatus 100. The display unit 140 according to an embodiment may only perform a display function, and may further include a touch screen function that may sense a touch of the user in addition to the display function. For example, in response to the digital apparatus 100 being a mobile phone or a digital camera containing a touch screen or a touch panel, the display unit 140 may further include the touch screen function in addition to the display function. Conversely, in response to the digital apparatus 100 being a digital TV for which the touch screen or the touch panel is not included, the display unit 140 may only include the display function.

The input unit 150 may receive a user control signal. For example, the input unit 150 may receive a movement control signal for movement in the areas on the user interface and a selection control signal to select the selection area on the user interface.

The communication unit 160 may communicate with another digital apparatus via a wireless communication network. In one example, the communication unit 160 may not use a wireless communication network such as an infrared ray communication, Bluetooth, WiFi, and the like.

The controller 170 may control a general operation of the digital apparatus 100. For example, the controller 170 may control the display unit 140 to display the user interface on the screen while the digital apparatus 100 operates in a standby mode in which the digital apparatus 100 does not execute a function menu.

Hereinafter, an example of a contents transmission performed in response to the display unit 140 including a display function and a touch screen function and an example of a contents transmission performed in response to the display unit 140 only including a display function are separately described.

In response to the display unit 140 including the touch screen function in addition to the display function, an operation of the controller 170 may be described as follows. In response to it being sensed that at least one contents list is dragged from the second area of the displayed user interface, and the dragged at least one contents list being dropped on at least one user list of the first area, the controller 170 may control the user interface generating unit 130 to dynamically display, on the third area, at least one function menu list applicable to the dragged at least one contents list. In one example, the third area may be displayed, on the first area and the second area, in a form of a popup window, and may be displayed together with the first area and the second area. The at least one function menu list may be reconstructed based on the contents list selected from the second area and may be displayed, regardless of an operation mode of the third area.

In response to the touch screen sensing that one of the at least one function menu list is selected from the third area, the controller 170 controls the communication unit 160 to transmit, using the selected function menu list, the dragged contents list to another digital apparatus corresponding to the user list in which the dragged contents list is dropped.

In response to the display unit 140 only including the display function, the operation of the controller 170 may be described as follows. The controller 170 may select a function menu list, a user list, and a contents list on the user interface based on a movement control signal or a selection control signal inputted to the input unit 150 while the user interface is displayed by the display unit 140. For example, the controller 170 may designate at least one selection area of each of the first area through third area based on the inputted movement control signal, and may select the function menu list, the user list, and the contents list, by selecting the designated selection area in response to the selection area being designated and the selection control signal is inputted.

The controller 170 may control the communication unit 160 to transmit, using a function menu list corresponding to the selection area selected from the third area, a contents list corresponding to the selection area selected from the second area to another digital apparatus corresponding to a user list corresponding to the selection area selected from the first area.

As described above, the digital apparatus 100 may display the user interface dynamically constructed based on the communication records and the usage records and thus, the user may conveniently transmit contents without searching for a user list and contents.

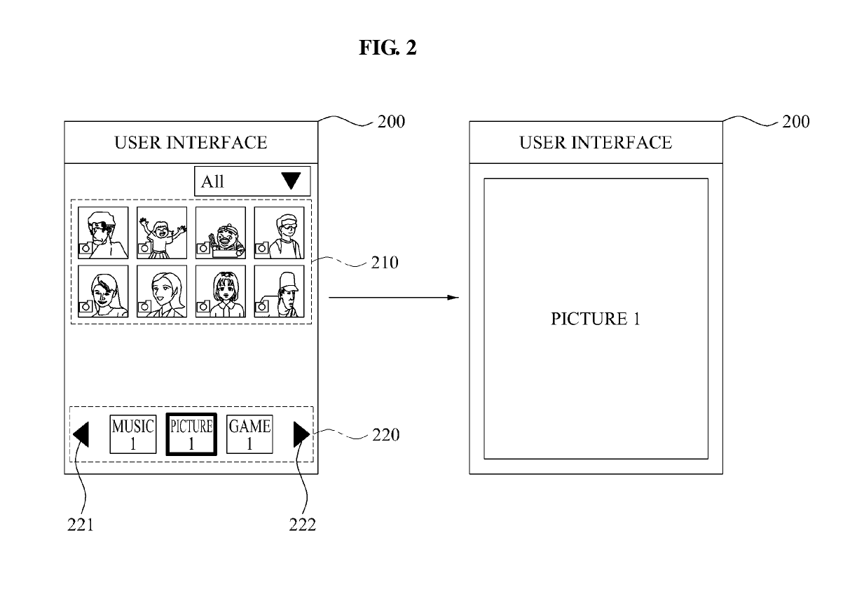

FIG. 2 illustrates an example of a user interface 200 generated by the digital apparatus 100. Referring to FIG. 2, the user interface 200 may be embodied in a digital apparatus 100, such as a mobile phone including a touch screen function.

The user interface 200 may include a first area 210 displaying a plurality of user lists stored in advance, and a second area 220 displaying a plurality of contents lists stored in advance. In one example, the plurality of user lists displayed on the first area 210 and the plurality of contents lists displayed on the second area 220 may be dynamically changed based on communication records and usage records of the digital apparatus 100.

For example, the digital apparatus 100 may update the communication records to manage the communication records every time the digital apparatus 100 communicates with another digital apparatus, and may update the usage records to manage the usage records every time at least one contents list among the plurality of contents lists is used. The digital apparatus 100 may change the lists displayed on the first area 210 and the second area 220 based on the communication records and the usage records, in response to the user interface 200 being generated.

The digital apparatus 100 may extract user lists having communication records up to a predetermined rank, and may arrange, on the first area 210, the extracted user lists in an order of a recent communication history, to generate the user interface 200. For example, as illustrated in FIG. 2, the digital apparatus 100 may extract the user lists having the communication records up to an rank number eight, and may arrange, on the first area 210, the extracted user lists in an order of the recent communication history, to generate the user interface 200.

The digital apparatus 100 may extract contents lists having usage records up to a predetermined rank, and may arrange, on the second area 220, the extracted contents lists, to generate the user interface 200. For example, as illustrated in FIG. 2, the digital apparatus 100 may extract the contents lists having the usage records up to a third rank, and may arrange, on the second area 220, the extracted contents lists, to generate the user interface 200.

A number of contents lists to be arranged on the second area 220 may be limited to, for example, three. Accordingly, in response to a number of the extracted contents lists being greater than or equal to three, arrows 221 and 222 may be marked in both sides in the second area 220 to indicate that another contents list exists. In response to the user's touching the arrow 221 or the arrow 222, the digital apparatus 100 may move a current contents list to a direction indicated by the corresponding arrow to display another contents list.

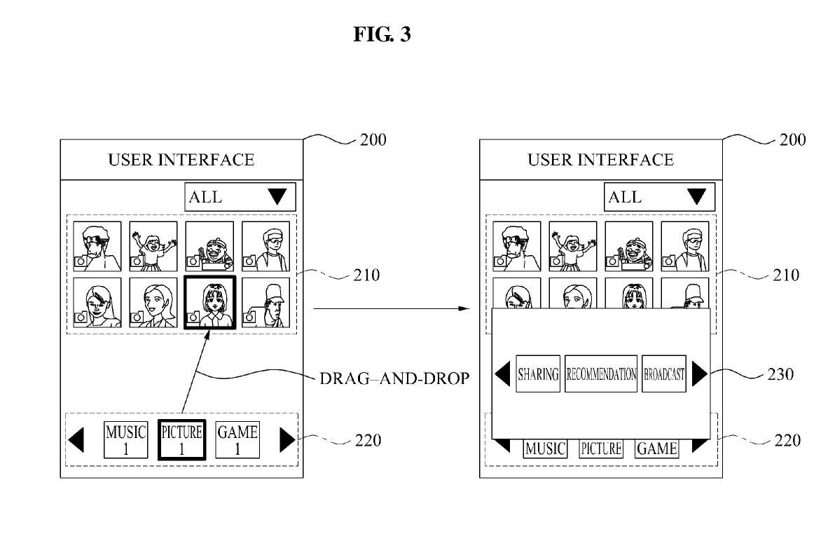

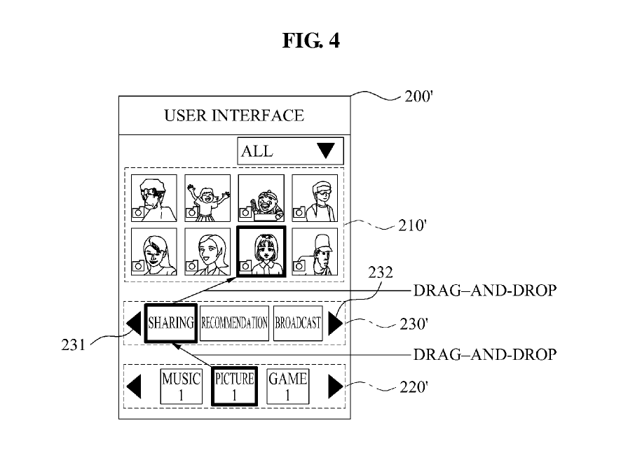

The user interface 200 may further include the third area dynamically displaying at least one function menu list applicable to a contents list. The third area will be described with reference to FIGS. 3 and 4.

As illustrated in FIG. 2, the user interface 200 may dynamically display the plurality of user lists on the first area 210 based on the communication records, and may dynamically display the plurality of contents lists on the second area 220 based on the user records. Accordingly, the user may conveniently utilize the user interface without searching for a user list and a contents list.

In response to the user's selecting a content list “picture 1” displayed on the second area 220 while the user interface 200 is displayed on the digital apparatus 100, the digital apparatus 100 may sense the selection and may display the contents list “picture 1,” as illustrated in the user interface 200 in a right side of FIG. 2. Accordingly, the user may easily display the contents using the user interface 200.

FIG. 3 illustrates an example of a contents transmitting method using the user interface 200 of FIG. 2. Referring to FIG. 3, the user interface 200 may be the same as the interface 200 of FIG. 2. The user interface 200 may be embodied in a digital apparatus 100, such as a mobile phone including a touch screen function.

As described above, a screen displaying the user interface 200 may include a touch screen function. Accordingly, the digital apparatus 100 may sense a touch of the user via a touch screen, may receive an input signal corresponding to the touch, and may perform an operation in response to the input signal.

For example, as illustrated in FIG. 3, in response to it being sensed that the contents list “picture 1” is dragged from the second area 220 and the dragged contents list “picture 1” is dropped on a seventh user list on the first area 210, the digital apparatus 100 may display the third area 230 dynamically displaying at least one function menu list applicable to the dragged contents list “picture 1.” For example, as illustrated in a right side of FIG. 3, the third area 230 may be displayed on the first area 210 and the second area 220 in a form of a popup window. The third area 230 may display the at least one function menu list, such as, “sharing,” “recommendation,” “broadcast,” etc., that are applicable to the contents list “picture 1” selected from the second area 220. In response to the contents list selected from the second area 220 being “music 1” or “game 1,” at least one function menu list applicable to the selected contents list is reconstructed to be displayed on the third area 230. Accordingly, the user may select one of the at least one function menu list displayed on the third area 230.

In response to it being sensed that the function menu list “sharing” is selected on the third area 230, the digital apparatus 100 may transmit the contents list “picture 1” to another digital apparatus corresponding to the seventh user list in which the contents list “picture 1” is dropped, using the selected function menu list “sharing.” Accordingly, the user may quickly and conveniently transmit contents by performing only a drag-and-drop and selecting a function menu list on the user interface 200.

FIG. 4 illustrates another example of a contents transmission method using the user interface 200′. Referring to FIG. 4, the user interface 200′ may be embodied in a digital apparatus 100, such as a mobile phone including a touch screen function as the user interface 200 of FIG. 2. A construction of a display and a type of an operation of the user interface 200′ are different from the user interface 200 of FIG. 2.

The user interface 200′ may include a first area 210′, a second area 220′, and a third area 230′. The first area 210′ may display a plurality of user lists stored in advance, the second area 220′ may display a plurality of contents list stored in advance, and the third area 230′ may dynamically display at least one function menu list applicable to a contents list.

The digital apparatus 100 may change, based on communication records and usage records, lists displayed on the first area 210′ and the second area 220′ in response to the user interface being generated, and may reconstruct a list displayed on the third area 230′ based on the contents list selected from the second area 220′. A number of contents lists to be arranged on the second area 220′ may be limited to, for example, three. In one example, in response to a number of reconstructed contents lists being greater than or equal to three, arrows 231 and 232 are marked in both sides in the third area 230′ to indicate that another contents list exists.

As illustrated in FIG. 4, in response to it being sensed that a contents list “picture 1” is dragged from the second area 220′, the digital apparatus 100 may reconstruct a function menu list applicable to the contents list “picture 1” and display the reconstructed function menu list on the third area 230′. In one example, in response to it being sensed that the dragged contents list “picture 1” is dropped on a function menu list “sharing” on the third area 230′ and the function menu list “sharing” is dragged and dropped on a seventh user list of the first area 210′, the digital apparatus 100 may transmit the content “picture 1” to another digital apparatus corresponding to the seventh user list using the function menu list “sharing.”

The user may quickly and conveniently transmit contents by performing only a drag-and-drop once, using the user interface 200.

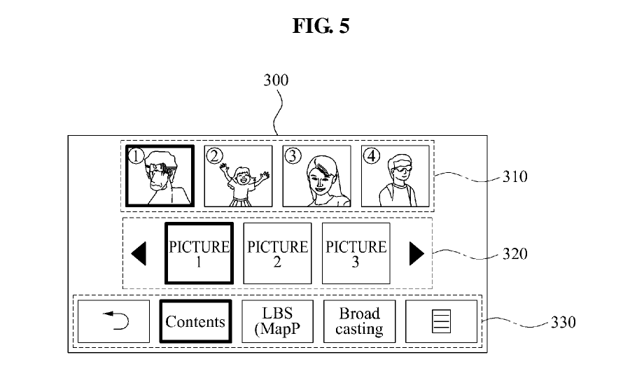

FIG. 5 illustrates another example of a user interface 300. Referring to FIG. 5, the user interface 300 may be provided in a digital apparatus 100, such as a digital camera, a camcorder, and the like including a touch screen function.

The user interface 300 may include a first area 310, a second area 320, and a third area 330 in the same manner as the user interface 200′ of FIG. 4. The first area 310 may display, based on communication records, user lists up to a predetermined communication rank among a plurality of user lists, the second area 320 may display, based on usage records, contents lists up to a predetermined usage record rank among a plurality of contents lists, and the third area 330 may display a plurality of function menu lists.

The user lists having communication records may be arranged on the first area 310 up to a fourth rank in an order of a recent communication history, and three contents lists having usage records may be arranged on the second area 320.

The plurality of user lists displayed on the first area 310 and the plurality of contents lists display on the second area 320 may be dynamically changed based on communication records and usage records of when the user interface 300 is generated.

The digital apparatus 100 may sense a touch of a user via a touch screen, may receive an input signal corresponding to the touch, and may perform an operation in response to the input signal.

For example, as illustrated in FIG. 5, in response to the user's selecting a first user list on the first area 310, selecting a contents list “picture 1” on the second area 320, and selecting a function menu list “contents communication” on the third area 330, each of the selected lists may be activated. In response to the list being respectively selected from the first area through third area 310, 320, and 330, the digital apparatus 100 may transmit the contents list “picture 1” to another apparatus corresponding to the first user list, using the function menu list “contents communication.”

Although an example where the lists are respectively selected from the first area through third area 310, 320, and 330 is described with reference to FIG. 5, the user interface 300 may also select the lists based on a drag-and-drop scheme as illustrated in FIG. 4.

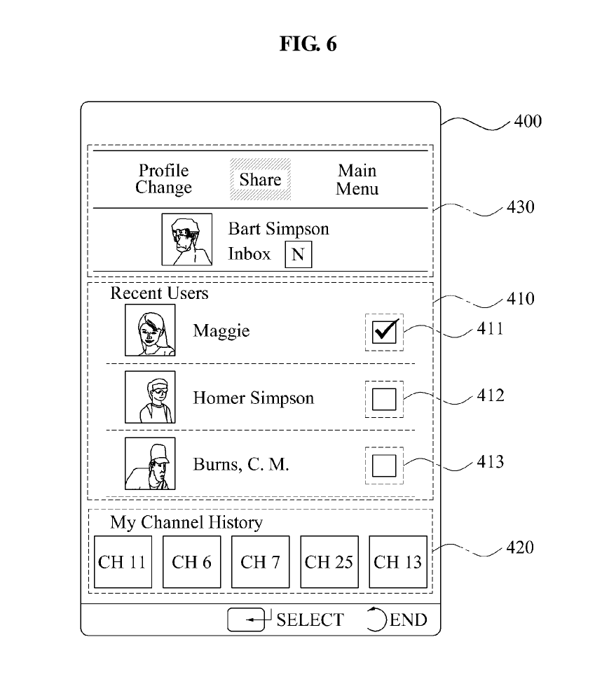

FIG. 6 illustrates still another example of a user interface 400. Referring to FIG. 6, the user interface 400 may be provided in a digital apparatus 100, such as a digital TV and the like.

In a case of a digital apparatus such as a digital TV, the digital apparatus 100 may not provide a touch screen, however, the user may input an input signal using a separate input device, such as a remote controller. Accordingly, a selection area may be included in a side of each list on the user interface 400.

Referring to FIG. 6, the user interface 400 may include a first area 410, a second area 420, and a third area 430. The first area 410 may display user lists, based on communication records, up to a predetermined communication record rank among a plurality of user lists stored in advance, the second area 420 may display, based on usage records, contents lists up to a predetermined usage record rank among a plurality of contents lists, and the third area 430 may display a plurality of function menu lists. In one example, a selection area 411, 412, or 413 may be further included in one side of each of the plurality of user lists of the first area 410. Although not illustrated in FIG. 5, a selection area may be further included in one side of each of the plurality of contents lists of the second area 420.

The contents list of the digital TV may include channel information and program information of the digital TV in addition to music, a picture, a movie stored in advance, and the like.

In response to a user input signal being received via the remote controller or an external input device, the digital apparatus 100 may perform an operation in response to the input signal.

For example, while the user interface 400 is displayed, in response to the user's designating, using the remote controller, a selection area corresponding to a first user list on the first area 410 and a selection key is inputted, the first user list may be selected. In the same manner, a contents list may be selected from the second area 420 and a function menu list may be selected from the third area 430.

As illustrated in FIG. 6, in response to the user's selecting the first user list on the first area 410, selecting a contents list “channel 7 (CH 7)” on the second area 420, and selecting a function menu list “sharing” on the third area 430, each of the selected lists may be activated. In response to the lists being respectively selected from the first area through the third area 410, 420, and 430, the digital apparatus 100 may transmit the contents list “CH 7,” e.g., broadcast information associated with CH 7, to another apparatus corresponding to the first user list, using the function menu list “sharing,”

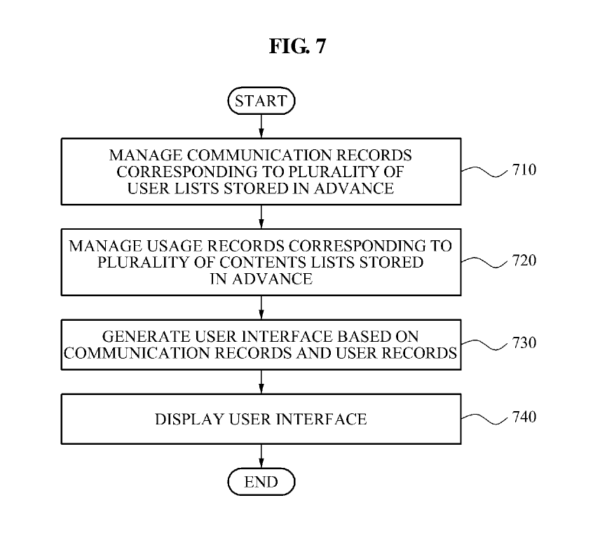

FIG. 7 illustrates an example of a user interface display method. Referring to FIG. 7, the digital apparatus 100 may manage communication records corresponding to a plurality of user lists stored in advance in operation 710. For example, the digital apparatus 100 may update the communication records to manage the communication records every time the digital apparatus 100 communicates with another digital apparatus corresponding to one of the plurality of user lists.

The digital apparatus 100 may manage usage records corresponding to a plurality of user lists stored in advance in operation 720. For example, the digital apparatus 100 may update the usage records to manage the usage records every time at least one contents list is used among a plurality of contents lists. In one example, the usage record of the contents lists may be updated every time the user generates contents, access the contents, and transmits a contents list to another digital apparatus.

Although operation 720 is performed after operation 710 in the example shown in FIG. 7, a sequence of performing the operation 710 and the operation 720 may not be limited thereto.

The digital apparatus 100 may generate a user interface based on communication records and usage records in operation 730. For example, the digital apparatus 100 may generate the user interface including a first area, a second area, and a third area. The first area may display, based on communication records, user lists up to a predetermined communication record rank among the plurality of user lists, the second area may display, based on usage records, contents lists up to a predetermined usage record rank among the plurality of contents lists, and the third area may display a plurality of function menu lists. In one example, the third area may be displayed together with the first area and the second area. Depending on cases, the third area may exist being hidden and may be displayed in a form of a popup window depending on a selection of a contents list. The third area may display a function menu list applicable to a contents list, and may dynamically construct the function menu list according to the contents list selected from the second area to display the constructed function menu list.

In operation 740, the digital apparatus 100 may display the user interface generated in operation 730 on a screen.

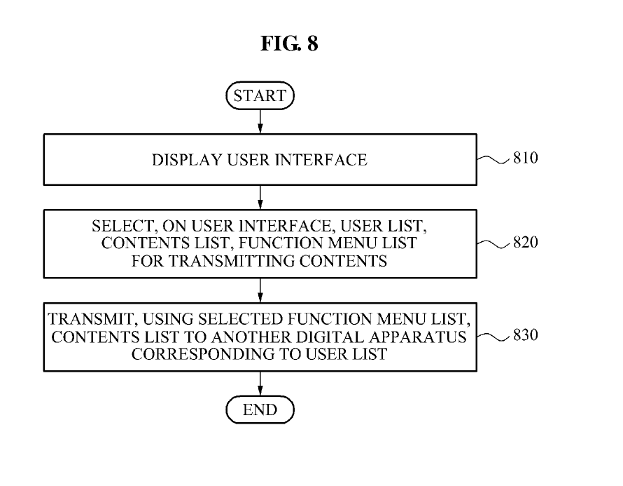

FIG. 8 illustrates an example of a contents transmitting method using a user interface. Referring to FIG. 8, the digital apparatus 100 may display a user interface for transmitting contents in operation 810. In one example, the user interface may be generated based on the method of FIG. 7, and may include a first area displaying a plurality of user lists, a second area displaying a plurality of contents lists, and a third area displaying a plurality of function menu lists. Accordingly, the user may select, on the user interface, a transmission target user list, a transmission target contents list, and a function menu list to be used for a contents transmission.

The digital apparatus 100 may receive selection signals with respect to a user list which is a target for a transmission, contents list, and a function menu list in operation 820. For example, the user touches a display screen with a hand to select, using a drag-and-drop method, the user list, the contents list, and the function menu list respectively from the first area through the third area on the user interface. The user may select, using a separate input device, the user list, the contents list, and the function menu list respectively from the first area through the third area of the user interface. Detailed example may be understood based on examples described with reference to FIGS. 2 through 6.

The digital apparatus 100 may transmit the contents lists to another digital apparatus corresponding to the user list, using the function menu list selected from the user interface in operation 830. For example, the digital apparatus 100 may transmit the contents list selected from the second area to another digital apparatus corresponding to the user lists selected from the first area, using the selected function menu list selected from the third area.

As described above, the user may transmit a user list, a contents list, and a function menu list by selecting the user list, the contents list, and the function menu list on a single user interface screen, and thus, may quickly and easily transmit contents.

The digital apparatus may dynamically construct, based on communication records and usage records, a user list, a contents list, and a function menu list on a user interface, and may provide a user list and a contents list that are frequently used for a contents transmission, and thus, may enable the user to quickly and easily transmit contents.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of example embodiments have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital apparatus, comprising:
a communication record management unit configured to manage communication records corresponding to a plurality of user lists stored in advance;
a contents usage record management unit configured to manage usage records corresponding to a plurality of contents lists stored in advance;
a user interface generating unit configured to generate a user interface including a first area, a second area, and a third area, the first area displaying, based on the communication records, user lists up to a predetermined communication record rank among the plurality of user lists, the second area displaying, based on the usage records, contents lists up to a predetermined usage record rank among the plurality of contents lists, and the third area dynamically displaying at least one function menu list that is applicable to the plurality of the displayed contents lists; and
a display unit configured to display the user interface.

2. The apparatus of claim 1, wherein the communication record management unit is further configured to update the communication records each time a communication with another digital apparatus corresponding to one of the plurality of user lists is performed.

3. The apparatus of claim 1, wherein the contents usage record management unit is further configured to update the usage records each time at least one contents list from among the plurality of contents lists is used.

4. The apparatus of claim 1, wherein the user interface generating unit is further configured to:
check the communication record management unit to extract user lists comprising communication records up to a predetermined rank; and
arrange, on the first area, the extracted user lists in an order of a recent communication history to generate the user interface.

5. The apparatus of claim 1, wherein the user interface generating unit is further configured to:
check the contents usage record management unit to extract contents lists comprising usage records up to a predetermined rank; and
arrange, on the second area, the extracted contents lists to generate the user interface.

6. The apparatus of claim 1, wherein the display unit comprises a touch screen is further configured to sense a touch of a user.

7. The apparatus of claim 6, further comprising a controller configured to control the user interface generating unit to dynamically display, on the third area, at least one function menu list applicable to at least one contents list, in response to the at least one contents list being dragged, on the touch screen, from the second area of the user interface and being dropped on at least one user list on the first area.

8. The apparatus of claim 7, wherein, in response to one of the at least one function menu lists being selected, the controller is further configured to control transmission, using the selected function menu list, of the dragged contents list to another digital apparatus corresponding to the user list where the dragged contents is dropped.

9. The apparatus of claim 1, wherein the user interface further comprises a selection area for the selection, in a side of each of the lists on the first area through the third area.

10. The apparatus of claim 9, further comprising:
an input unit configured to receive one of: a movement control signal for a movement in the selection area and a selection control signal configured to select the selection area; and
a controller configured to:
designate at least one selection area in each of the first area through the third area based on the movement control signal; and
select the designated selection area in response to the selection control signal being inputted while the selection area is designated.

11. The apparatus of claim 10, wherein the controller is further configured to control transmission of a contents list of the selection area selected from the second area to another digital apparatus corresponding to a user list of the selection area selected from the first area, using a function menu list of the selection area selected from the third area of the displayed user interface.

12. A user interface display method, comprising:
managing communication records corresponding to a plurality of user lists stored in advance;
managing usage records corresponding to a plurality of contents lists stored in advance;
generating a user interface including a first area, a second area, and a third area, the first area displaying, based on the communication records, user lists up to a predetermined communication record rank among the plurality of user lists, the second area displaying, based on the usage records, contents lists up to a predetermined usage record rank among the plurality of contents lists, and the third area dynamically displaying at least one function menu list that is applicable to the plurality of the displayed contents lists; and
displaying the user interface.

13. The method of claim 12, wherein the managing of the communication records comprises updating the communication records each time a communication with another digital apparatus corresponding to one of the plurality of user lists is performed.

14. The method of claim 12, wherein the managing of the usage records comprises updating the usage records each time at least one contents list from among the plurality of contents lists is used.

15. The method of claim 12, wherein the generating comprises:
extracting user lists comprising communication records up to a predetermined rank; and
arranging, on the first area, the extracted user lists in an order of a recent communication history to generate the user interface.

16. The method of claim 12, wherein the generating comprises:
extracting contents lists comprising usage records up to a predetermined rank; and
arranging, on the second area, the extracted contents lists to generate the user interface.

17. The method of claim 12, wherein the generating comprises dynamically displaying, on the third area, at least one function menu list applicable to at least one contents list, in response to the at least one contents list being dragged, on the touch screen, from the second area of the user interface and being dropped on at least one user list on the first area.

18. The method of claim 17, further comprising, in response to one of the at least one function menu lists being selected, transmitting, using the selected function menu list, the dragged contents list to another digital apparatus corresponding to the user list where the dragged contents is dropped.

19. The method of claim 12, wherein the user interface further comprises a selection area for the selection, in a side of each of the lists on the first area through the third area.

20. The method of claim 19, further comprising:
designating at least one selection area in each of the first area through the third area based on a movement control signal for a movement in the selection area;
selecting the designated selection area in response to the selection control signal for selecting the selection area being inputted while the selection area is designated; and
transmitting a contents list of the selection area selected from the second area to another digital apparatus corresponding to a user list of the selection area selected from the first area, using a function menu list of the selection area selected from the third area of the displayed user interface.
